(19) United States
(12) Patent Application Publication
(10) Pub. No.: US 2008/0236028 A1
(43) Pub. Date: Oct. 2, 2008

(54) Flying insect trapping system

(76) Inventors: William B. McBride, Tallahassee, FL (US); Scott C. Helzer, Tallahassee, FL (US)

Correspondence Address: Peter Loffler, P.O. Box 1001, Niceville, FL, 32588-1001, US

(21) Appl. No.: 11/731,587

(22) Filed: Apr. 2, 2007

(51) Int. Cl. A01M 1/08; A01M 1/02

(52) U.S. Cl. 43/139; 43/107; 43/113

(57) ABSTRACT

A flying insect trapping system uses a control assembly that has a dispersion assembly that vaporizes small amounts of octenol, the octenol mixing with carbon dioxide the flow of which is regulated into a mixing housing. The mixture is released to attract flying insects from a distance. A trapping assembly uses a heat source, namely a light for short distance attraction of the insects, which insects fly to the light and are drawn into a mesh by a fan. Each trapping assembly can have a control assembly associated with it, or a single master control assembly can be used which delivers the carbon dioxide and octenol mixture to each of the trapping assemblies.

### BACKGROUND OF THE INVENTION

1. Field of the Invention

The present invention relates to a system that attracts and traps flying insects, namely mosquitoes, in order to be able to rid an area of the insects.

2. Background of the Prior Art

Most people hate mosquitoes. Besides the annoyance, the itching, and the resulting infections of their bites, mosquitoes carry diseases such as malaria, yellow fever, dengue fever, encephalitis, and West Nile virus. Numerous control methods have been used including body coverings and coatings, fans, nets, zappers, and slapping and swatting the varmints. However, such methods may be uncomfortable to implement for the user or offer no more than short-term help while some methods do not work whatsoever and some methods are dangerous.

Several years ago, the U.S. Coast Guard, tired of wrestling with mosquitoes, no-see-ums, and other biting bugs that infested their stations, commissioned entomologists at the University of Florida to research how these insects locate us in order to bite us so that control methods might be improved based on the findings.

It has been known for some time that the female mosquito requires a blood meal in order to obtain protein that is necessary for laying eggs, which blood she obtains by biting.

Humans, other mammals, and birds inhale air and exhale, among other things, carbon dioxide (CO2) and octenol, a byproduct of the digestive process. While there are other odors that are attractants to these insects—foot odor, which has a molecule similar to that found in Limburger cheese, is one such mild attractant—carbon dioxide and octenol are by far the most attractive. Heat in the range of human body temperature and dark colors are also attractants.

Mosquitoes have heat receptors and odor receptors on their heads in order to assist them in finding us so that they can get their blood meal from us. The odor receptors can pick up the attractive odors as far away as 135 feet downwind from the source of the odor. The mosquito flies upwind until she is about 25 feet away at which time the heat receptors guides her in for a landing—and a lunch.

Building on this research, a number of prior art devices have been proposed. Most such prior art devices use either CO2, octenol, or both as an odor attractant, while some also use heat as an attractant, although none are known to use old tennis shoes. Devices that use CO2 either use commercially available CO2 or produce the CO2 by burning propane. Devices that produce heat typically produce the heat by using 110-volt electric heat strips or by burning propane. The insects are killed by retaining them in a bag and desiccating them, trapping them on a sticky substance such as flypaper, or by zapping them with a high-voltage bug zapper.

The prior art devices suffer from one or more drawbacks. Untended propane fires that are used to produce CO2 and heat are potentially dangerous. Not only can a fire spread from the burning propane, regulators, valves and hoses, but the propane tanks can explode. Further, burning propane and other gasses in order to produce CO2 contributes to airborne pollution and global warming. CO2 from bottles is obtained from and released back to the atmosphere, thereby avoiding adding more CO2 to the atmosphere. The bug zappers explode all insects that come into contact with them. While such zappers do zap mosquitoes and no-see-ums, they also kill other (possibly desirable) insects. Additionally, adding zapped bug parts, and at times small metallic molecules that burn off from the metallic zapper, to the family barbecue and to the air that is breathed is neither recommended nor desired. The use of high voltage electricity outdoors can be dangerous if not properly installed and maintained, especially in the rain and around pools. Along with killing the insects, such devices have the potential to kill the user as well. Many prior art devices are unusually complex in design and construction, making such devices relatively expensive to manufacture and to maintain, thus less attractive to the consumer market.

In our prior U.S. Pat. No. 6,898,896 incorporated herein in its entirety by reference, we have invented an Insect Trap System that overcomes the above-stated problems in the art. Specifically, the insect trap eliminates the need for the use of propane for any reason. The trap is substantially targeted at killing the bad insects, namely mosquitoes, while not acting as an attractant to good insects which are not to be killed. The device does not add unwanted materials to food for humans found in the area of the device or to the surrounding air and does not rely on a source of high voltage for its operation. Our insect trap is simple in design and construction making it relatively easy to manufacture making the device relatively inexpensive and thus attractive to a large section of the consumer market.

Our insect trap works by providing a series of housings that are positioned about the perimeter of an area to be protected against the mosquitoes. Each housing has a heat source to attract the mosquitoes and a trap for trapping the insects. Octenol and carbon dioxide are combined and pumped through conduits connected to each housing whereat the octenol and the carbon dioxide are released in order to attract the mosquitoes to the housing for subsequent trapping of the mosquito within the housing. The combined use of carbon dioxide and octenol dramatically increases their effectiveness relative to the use of each attractant alone.

It has been found that controlled release of the octenol is desirous in order to keep the operating costs of the system as low as possible. While any appropriate dispersion method of the octenol allows the insect trap to work properly, due to the relatively high cost of the octenol, controlled release of the octenol is advantageous. Controlled release of the carbon dioxide further helps to maintain operating costs low. Additionally, pulsed release of the gases increases their effectiveness as attractants by mimicking exhalation of those gases.

### SUMMARY OF THE INVENTION

The flying insect trapping system of the present invention allows for the smooth and controlled release of an appropriate liquid attractant, such as octenol, through an insect trap so as to allow a sufficient amount of the attractant, as well as carbon dioxide, to be released without undue waste of either product. This allows the operating costs of the system to be kept low and also has the added benefit that less frequent replenishment of the system is required in order to keep the flying insect trapping system functioning properly.

The flying insect trapping system of the present invention is comprised of a control assembly that has a first housing with an opening, a first valve that is fluid flow connected to a source of carbon dioxide located external of the first housing, a puffer assembly that holds a liquid and vaporizes a portion of the liquid via a piezoelectric igniter, and a controller for controlling the valve and the igniter. A trapping assembly has a second housing that contains a light, a fan, and a mesh. The first valve periodically opens in order to allow the carbon dioxide to enter the first housing and the igniter periodically sparks in order to vaporize a portion of the liquid which liquid mixes with the carbon dioxide to form a mixture and the mixture is released from the first housing via the opening and wherein the light attracts the insects such that the insects get caught in an air stream produced by the fan and are trapped in the mesh. The liquid used by the puffer assembly is octenol. Each trapping assembly may have its own control assembly associated with it such that the first housing and the second housing are attached to a post and each controller controls the light and fan of the trapping assembly associated with that controller, or a single controller is used for all trapping assemblies and a conduit extends between the opening and each trapping assembly and the single controller controls the lights and fans of each of the trapping assemblies. A second valve may be located within the first housing at the conduit such that this second valve periodically opens to allow the mixture to enter the conduit.

### BRIEF DESCRIPTION OF THE DRAWINGS

FIG. 1 is a perspective view of the flying insect trapping system of the present invention.

FIG. 2 is a sectional view of the controller of the flying insect trapping system taken along line 2-2 in FIG. 1.

FIG. 3 is a sectional view of the trap assembly of the flying insect trapping system taken along line 3-3 in FIG. 1.

FIG. 4 is a sectional view of the flying insect trapping system in operation.

FIG. 5 is a plan view of multiple flying insect trapping system units protecting a golf course hole.

FIG. 6 is a sectional view of the controller of the flying insect trapping system utilizing a wick dispenser.

FIG. 7 is an elevation view of the plug and wick assembly

FIG. 8 is a perspective view of an alternate embodiment of the flying insect trapping system of the present invention

FIG. 9 is a sectional view of the flying insect trapping system of FIG. 8 in operation taken along line 9-9 in FIG. 8.

FIG. 10 is a perspective view of the flying insect trapping system of FIG. 8.

FIG. 11 is a sectional view of the controller of the flying insect trapping system of FIG. 8, taken along line 11-11 in FIG. 10, utilizing a piezoelectric crystal.

FIG. 12 is a sectional view of the controller of the flying insect trapping system of FIG. 8 utilizing the wick dispenser.

Similar reference numerals refer to similar parts throughout the several views of the drawings.

### DESCRIPTION OF THE PREFERRED EMBODIMENT

Referring now to the drawings, it is seen that the flying insect trapping system of the present invention, generally denoted by reference numeral 10, is comprised of a controller system 12 and a trapping assembly 14. The control system 12 is responsible for controlling and dispensing of attractants such as carbon dioxide 16 and octenol 18 and overall electrical control of the system 10 while the trapping assembly 14 is responsible to trapping and eliminating the insects that fly to the trapping assembly 14. As seen, the control system 12 comprises a housing 20 that has a divider 22 within its interior, the divider 22 being optional. On one side of the divider 22 (if used, otherwise all components are located within a single chamber) is a controller 24 which is a circuit board that electrically connects to and controls the functioning of the various components discussed below, which circuit board 24 is connected to a source of electrical power (not illustrated) by appropriate wiring 26. Also located within this side of the divider 22 is a valve 28 that has an inlet port 30 that is fluid flow connected to a source of carbon dioxide 16 by the illustrated conduit 32. The valve 28 has an outlet port 34 that passes through the divider 22 into the other half of the housing 20. Appropriate wiring 36 electrically connects the valve 28 with the controller 24.

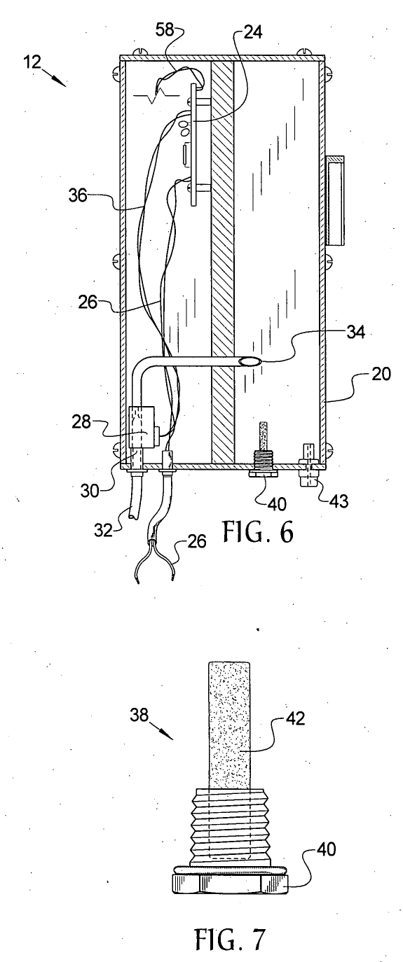

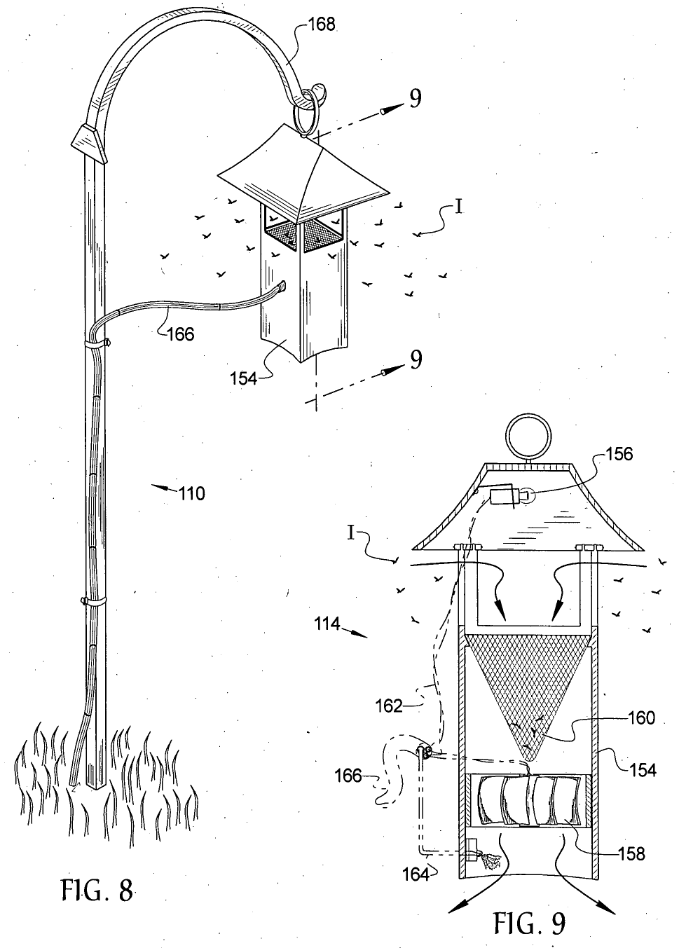

Located on the other side of the divider 22 (if used) within the housing 20 is a dispersion assembly 38 which, as seen in FIG. 6, includes a threaded plug 40 that has a wick 42 extending therefrom, the plug 40 being threadably receivable within an opening located on the bottom of the housing 20. The wick 42 is dipped into an appropriate insect attractant 18, in the case of mosquitoes—octenol is a great candidate—such that the attractant 18 slowly diffuse from the wick 42 after installation within the housing 20. Of course the wick 42 and plug 40 assembly are kept in an airtight package (not illustrated) prior to use so that the attractant 18 does not dissipate during shipment from the factory and while awaiting purchase. A pressure release valve 43 can be located on the housing 20. As discussed more fully below, an alternate dispersion assembly can be used.

Alternately, the dispersion assembly 38′ can be used for releasing the attractant 18 into the housing 20 for mixing with the carbon dioxide 16, which dispersion assembly 38′ has a receptacle 44 that holds the attractant 18 therein and which is threadably secured to the housing 20 for easy removal and refilling of the receptacle 44. A wick 46 extends from a piezoelectric igniter 48 into the receptacle 44 and into the attractant 18. The dispersion assembly 38′ operates by having the wick 46 wick up the octenol 18. The piezoelectric igniter 48 sparks the octenol infused wick 46 causing a small amount of the octenol 18 to vaporize. Appropriate wiring 49 electrically connects the dispersion assembly system 38′ with the controller 24. Also located within this side of the divider 22 within the housing 20 is a pressure release valve 43 which may but need not be located on the bottom of the housing 20.

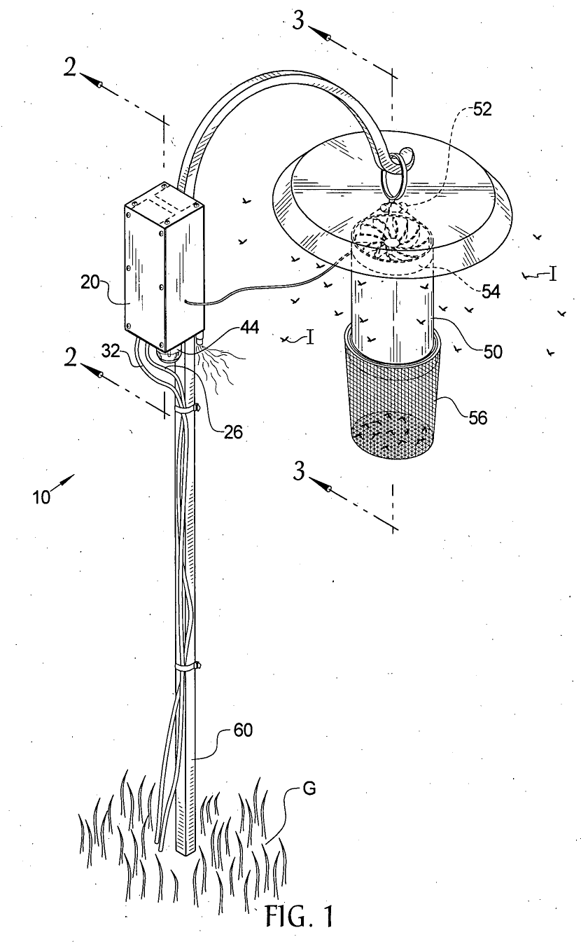

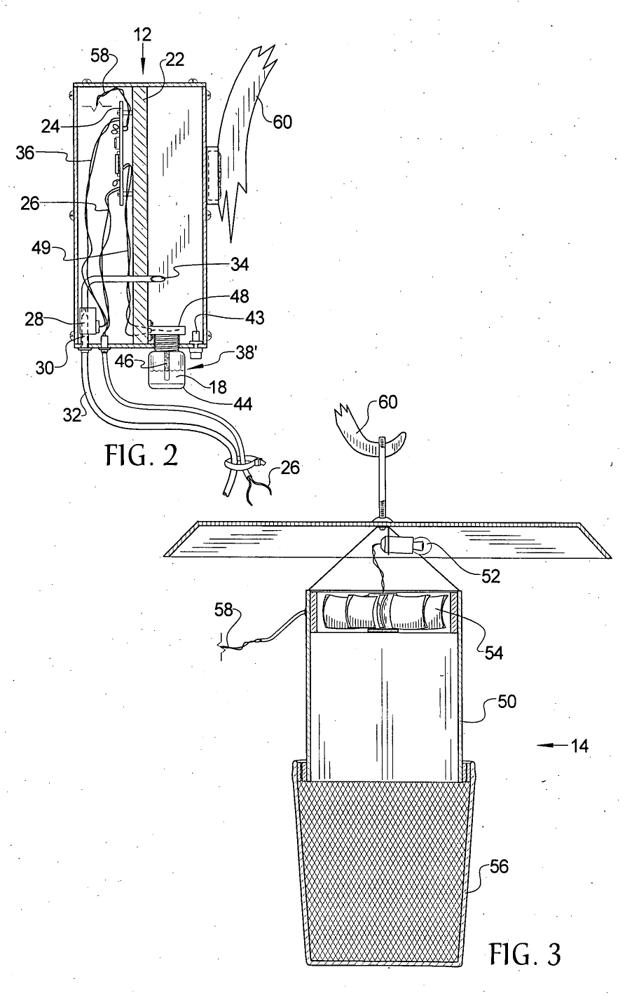

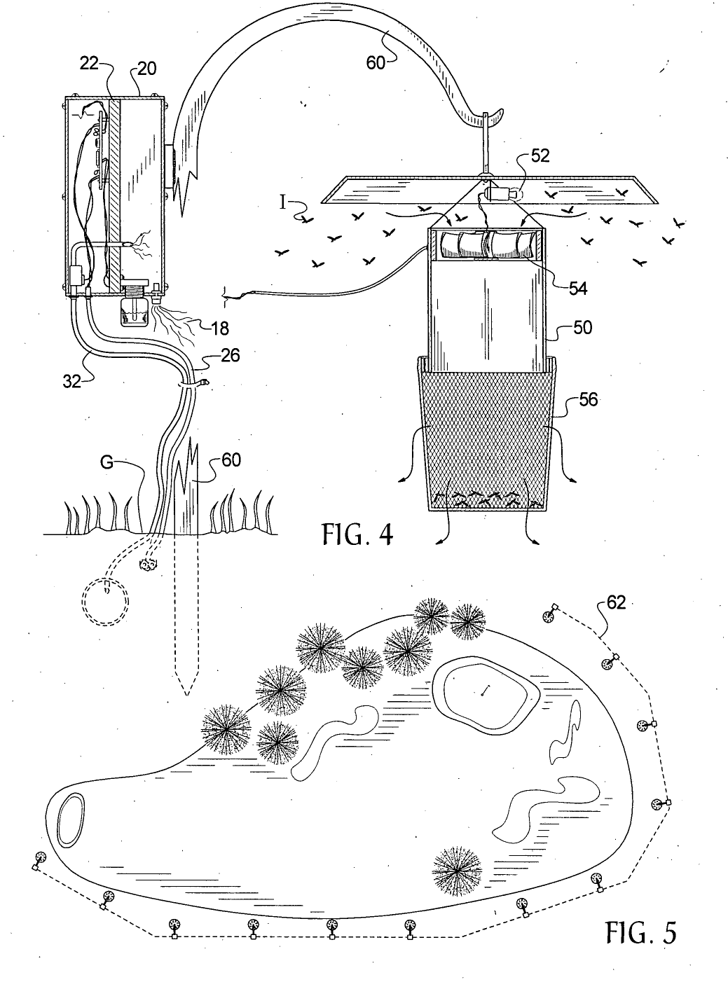

As seen, the trapping assembly 14 is comprised of a housing 50 that has a light 52 (a source of heat to attract the mosquitoes) and a fan 54 located below the light 52. A mesh 56 is located in the air flow stream of the fan 54, as illustrated in FIGS. 1, 3, and 4, below the fan 54, or as illustrated in FIG. 9, above the fan 158. The housing 50 of the trapping assembly 14 is constructed so as to be aesthetically pleasing at the site of installation. Appropriate wiring 58 electrically connects the light 52 and the fan 54 with the controller 24. Both the control system 12 and the trapping assembly 14 are located on an appropriate post 60 that is secured within the ground G in any appropriate manner known in the art.

In operation, one or more posts 60 that each hold a control system 12 and a trapping assembly 14 are positioned about an area to be protected from flying insects I and secured to the ground G as appropriate. A plug 40 and wick assembly 42 are obtained and the plug 40 is screwed into an opening 44 in the housing 20. Each carbon dioxide conduit 32 is fluid flow connected to a source of pressurized carbon dioxide 16. Each conduit 32 can be individually connected to the source of carbon dioxide 16 or each individual conduit 32 can be connected to a manifold 62 wherein the manifold 62 is connected to the source of carbon dioxide 16 (connection not illustrated). The controller 24 is connected to a source of electrical power in appropriate fashion. In operation, the carbon dioxide 16 flows through the conduits 32 and presents at the valve 28. Periodically, the valve 28 opens and allows some of the pressurized carbon dioxide 16 to pass through the valve 28 and enter the half (if divided) of the housing 20 having the puffer system 38. The time interval of valve 28 opening as well as the duration of the opening are dependent on the infestation level of the insects I, the number of individual units and configuration of installation, the wind speed, the humidity, and other factors and is programmable by the user. Typically valve 28 openings every 2 to 15 seconds for a period of about ⅛ second to about ½ second prove satisfactory. The valve opening frequency and duration are designed to approximate the natural breathing cycle of a mammal so that opening and duration parameters outside of these limits may also prove satisfactory. The attractant 18 diffuses from the wick 42. The carbon dioxide 16 and the diffused attractant 18 are mixed and escape from the housing 20 through the pressure release valve 43. The released carbon dioxide 16 and attractant 18 attract the flying insects I from far away and bring them to the trapping assembly 14. Once the insects I are close to the trapping assembly 14, they are attracted by the heat given off by the light 52 and fly to the light 52. Once the insects I fly sufficiently close to the light 52, they are trapped in the air stream produced by the fan 54, which air stream pushes the insects I into the mesh 56 wherein the insects I are trapped and desiccated. Once the mesh 56 is sufficiently full of insects I, the mesh 56 is removed and is cleaned or replaced with a new mesh 56.

This present system allows for large areas to be cleared out of flying insects I so that the area may be more enjoyable to humans. By having periodic release of carbon dioxide 16 and wicked release of the octenol 18, these valuable resources are sparingly used thereby decreasing the overall operating cost of the system 10. As the source of carbon dioxide 16 is located remote from the control system 12 and trapping assemblies 14, the flying insect trapping system 10 traps and kills flying insects I in an aesthetically pleasing and functional configuration.

Each conduit 32, electrical power wiring 26, and manifold 62 are disposed in a subterranean manner except where needed to connect with a control system 12.

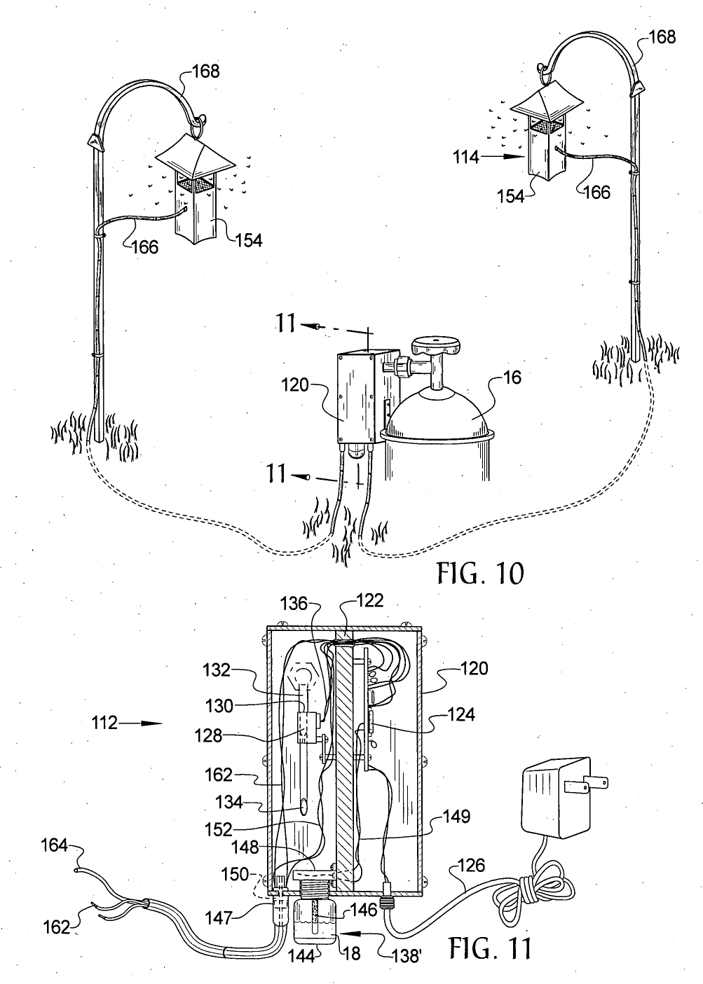

As seen in FIGS. 10-12, a simplified version of the flying insect trapping system 110 is disclosed. This simplified version also uses a control system 112 and a trapping assembly 114, however, a single control system 112 is used irrespective of the number of trapping assemblies 114. As seen, the control system 112 also uses a housing 120 having an optional divider 122 therein to divide the interior of the housing 120 into two sections. A controller 124 is located within the housing 120 which controller 124 is connected to a source of electrical power by appropriate wiring 126. Located on the opposite side of the divider 122 is a valve 128 that has an inlet port 130 that is fluid flow connected to a source of carbon dioxide 16 by the illustrated conduit 132. The valve 128 has an outlet port 134. Appropriate wiring 136 electrically connects the valve 128 with the controller 124.

Located on this side of the divider 122 within the housing 120 is a dispersion assembly system 138′ which has a receptacle 144 that holds octenol 18 therein and which is threadably secured to the housing 120 for easy removal and refilling of the receptacle 144. A wick 146 extends from a piezoelectric crystal 148 into the receptacle 144 and into the octenol 18. The dispersion assembly system 138′ operates as described above. Appropriate wiring 149 electrically connects the puffer system 138′ with the controller 124. Also located within this side of the divider 122 within the housing 120 is a nozzle 147 which may but need not be located on the bottom of the housing 120 which nozzle 147 is controlled by the controller 124 with the nozzle 147 connected to the controller 124 by appropriate wiring 162. This version of the dispersion assembly 138′ can be used with the previous embodiment of the system 10.

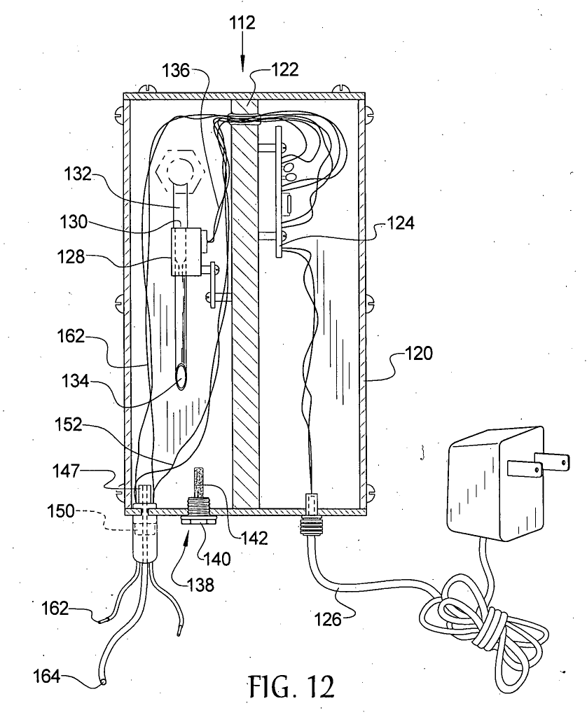

As seen in FIG. 12, the attractant dispersion system 138 may alternately be a plug 140 with a wick 142 extending therefrom, the wick 142 having attractant absorbed therein, the plug 140 threadably received within an opening of the housing 120, all other aspects of the system being the same.

As seen, the trapping assembly 114 is substantially similar to the previous trapping assembly 14 and is comprised of a housing 154 that has a light 156 (a source of heat to attract the mosquitoes) and a fan 158 located below the light 156. A mesh 160 is located in the air flow stream of the fan 158. The housing 154 of the trapping assembly 114 is constructed so as to be aesthetically pleasing at the site of installation. Appropriate wiring 162 electrically connects the light 156 and the fan 158 with the controller 124 while a fluid conduit 164 extends between the nozzle 147 and each trapping assembly 114, the fluid conduit 164 and the wiring 162 being disposed within a protective conduit 166. The fluid conduit 164 may terminate just below the fan 158 so that its bounty, described below, is released into the air stream of the fan 158 for better dispersion of the bounty. Each trapping assembly 114 is located on an appropriate post 168 that is secured within the ground G in any appropriate manner known in the art.

In operation, one or more posts 168 that each hold a trapping assembly 114 are positioned about an area to be protected from flying insects I and secured to the ground G as appropriate. Each receptacle 144 is filled with octenol 18 or other desired attractant and threadably attached to the housing 120 for dispersion via the piezoelectric igniter 148. Alternately, a plug 140 and wick assembly 142 is obtained and the plug 140 is threadably received attached to the housing 120. The conduit 132 is fluid flow connected to a source of pressurized carbon dioxide 16. The controller 124 is connected to a source of electrical power in appropriate fashion. In operation, the carbon dioxide 16 flows through the conduit 132 and presents at the valve 128. Periodically, the valve 128 opens allows some of the pressurized carbon dioxide to pass through the valve 128 and enter the half (if so divided) of the housing 120 having the attractant dispersion system 138. The time interval of valve 128 opening as well as the duration of the opening are dependent on the infestation level of the insects I, the number of individual units and configuration of installation, the wind speed, the humidity, and other factors and is programmable by the user. Typically valve openings every 2 to 15 seconds for a period of about ⅛ second to about ½ second proves satisfactory. The valve opening frequency and duration are designed to approximate the natural breathing cycle of a mammal so that opening and duration parameters outside of these limits may also prove satisfactory. Also periodically, the dispersion assembly 138′, if used to release the attractant 18, causes the piezoelectric igniter 148 to spark in order to vaporize a small amount of octenol 18. Like control of the valve 128, the time interval of igniter 148 operation is dependent on the infestation level of the insects I, the number of individual units and configuration of installation, the wind speed, the humidity, and other factors and is programmable by the user. Typically intervals between sparks are on the order of about every 2 to 15 seconds although interval parameters outside of these limits may also prove satisfactory. The carbon dioxide 16 and the vaporized octenol 18 (the octenol 18 may be released via evaporation from the wick 142) are mixed and built up within the housing 120. Periodically, the valve 150 on the nozzle 147 is opened in order to allow the mixed carbon dioxide 16 and octenol 18 to pass into the fluid conduit 164 which carries the mixed carbon dioxide 16 and octenol 18 to each of the trapping assemblies 114. The time interval of valve 150 opening as well as the duration of the opening are dependent on the infestation level of the insects I, the number of individual units and configuration of installation, the wind speed, the humidity, and other factors and is programmable by the user. Typically valve 150 openings every 2 to 15 seconds for a period of about ⅛ second to about ½ second proves satisfactory. The valve opening frequency and duration are designed to approximate the natural breathing cycle of a mammal so that opening and duration parameters outside of these limits may also prove satisfactory.

The released carbon dioxide 16 and octenol 18 attract the flying insects I from far away and bring them to the trapping assembly 114. Once the insects I are close to the trapping assembly 114, they are attracted by the heat given off by the light 156 and fly to the light 156. Once the insects I fly sufficiently close to the light 156, they are trapped in the air stream produced by the fan 158, which air stream draws the insects I into the mesh 160 wherein the insects I are trapped and desiccated. Once the mesh 160 is sufficiently full of insects I, the mesh 160 is removed and is cleaned or replaced with a new mesh 160.

This second embodiment 110 is best used when the number of deployed trapping assemblies 114 is limited. The protective conduit 166 holding the fluid conduit 164 and the electrical power source wiring 126 is disposed in a subterranean manner except where needed to connect with a trapping assembly 114.

While the invention has been particularly shown and described with reference to embodiments thereof, it will be appreciated by those skilled in the art that various changes in form and detail may be made without departing from the spirit and scope of the invention.

We claim:

1. A trapping system for trapping flying insects, the trapping system comprising:
a control assembly that has a first housing having an opening, a first valve fluid flow connected to a source of carbon dioxide located external of the first housing, a dispersion system that holds an attractant and diffuses a portion of the attractant, and a controller for controlling the valve;
a trapping assembly having a second housing that has a light, a fan, and a mesh; and
wherein the first valve periodically opens in order to allow the carbon dioxide to enter the first housing and the diffused attractant mixes with the carbon dioxide to form a mixture and the mixture is released from the first housing via the opening and wherein the light attracts the insects such that the insects get caught in an air stream produced by the fan and are trapped in the mesh.

2. The trapping system as in claim 1 wherein the attractant is octenol.

3. The trapping system as in claim 1 wherein the first housing and the second housing are attached to a post.

4. The trapping system as in claim 1 wherein the controller controls the light and the fan.

5. The trapping system as in claim 1 further comprising a conduit extending between the opening and the trapping assembly.

6. The trapping system as in claim 5 further comprising a second valve located within the first housing at the conduit such that the second valve periodically opens to allow the mixture to enter the conduit.

7. The trapping system as in claim 1 wherein the dispersion system comprises a plug having a wick that has absorbed the attractant, the plug being removably received within the first housing.

8. The trapping system as in claim 1 wherein the dispersion system comprises a receptacle holding the attractant, the receptacle being removably received within the first housing, a wick that absorbs the attractant, and a piezoelectric crystal that ignites and vaporizes a portion of the attractant on the wick, the piezoelectric crystal being controlled by the controller.

9. The trapping system as in claim 1 wherein the dispersion system is selected from the group consisting of a plug having a first wick that has absorbed the attractant, the plug being removably received within the first housing, and a receptacle holding the attractant, the receptacle being removably received within the housing, a second wick that absorbs the attractant, and a piezoelectric crystal that ignites and vaporizes a portion of the attractant on the wick, the piezoelectric crystal being controlled by the controller.

10. A trapping system for trapping flying insects, the trapping system comprising:
a control assembly that has a first housing having an opening, a first valve fluid flow connected to a source of carbon dioxide located external of the first housing, a dispersion system that holds an attractant and diffuses a portion of the attractant, and a controller for controlling the valve;
a first trapping assembly having a second housing that has a first light, a first fan, and a first mesh;
a second trapping assembly having a third housing that has a second light, a second fan, and a second mesh;
a conduit extending between the opening and the second housing and the third housing; and
wherein the first valve periodically opens in order to allow the carbon dioxide to enter the first housing and the dispersion system diffuses a portion of the attractant which mixes with the carbon dioxide to form a mixture and the mixture enters the conduit and flows to the second housing and the third housing and wherein the first light attracts some of the insects such that the insects get caught in a first air stream produced by the first fan and are trapped in the first mesh and the second light attracts some of the insects such that the insects get caught in a second air stream produced by the second fan and are trapped in the second mesh.

11. The trapping system as in claim 10 wherein the liquid is octenol.

12. The trapping system as in claim 10 wherein the second housing is attached to a first post and the third housing is attached to a second post.

13. The trapping system as in claim 10 wherein the controller controls the first light, the second light, the first fan, and the second fan.

14. The trapping system as in claim 10 further comprising a second valve located within the first housing at the conduit such that the second valve periodically opens to allow the mixture to enter the conduit.

15. The trapping system as in claim 10 wherein the dispersion system comprises a plug having a wick that has absorbed the attractant, the plug being removably received within the first housing.

16. The trapping system as in claim 10 wherein the dispersion system comprises a receptacle holding the attractant, the receptacle being removably received within the first housing, a wick that absorbs the attractant, and a piezoelectric crystal that ignites and vaporizes a portion of the attractant on the wick, the piezoelectric crystal being controlled by the controller

17. The trapping system as in claim 10 wherein the dispersion system is selected from the group consisting of 4a plug having a first wick that has absorbed the attractant, the plug being removably received within the first housing, and a receptacle holding the attractant, the receptacle being removably received within the first housing, a second wick that absorbs the attractant, and a piezoelectric crystal that ignites and vaporizes a portion of the attractant on the wick, the piezoelectric crystal being controlled by the controller

18. A trapping system for trapping flying insects, the trapping system comprising:
a first control assembly that has a first housing having a first opening, a first valve fluid flow connected to a source of carbon dioxide located external of the first housing, a dispersion system that holds an attractant and diffuses a portion the attractant, and a first controller for controlling the first valve;
a second control assembly that has a second housing having a second opening, a second valve fluid flow connected to the source of carbon dioxide located external of the second housing, a second dispersion system that holds the attractant and diffuses a portion of the attractant, and a second controller for controlling the second valve;
a first trapping assembly having a third housing that has a first light, a first fan, and a first mesh; and
wherein the first valve periodically opens in order to allow the carbon dioxide to enter the first housing and the first diffusion system diffuses a portion of the attractant which attractant mixes with the carbon dioxide to form a mixture and the mixture is released from the first housing via the first opening and wherein the first light attracts some of the insects such that the insects get caught in a first air stream produced by the first fan and are trapped in the first mesh and the second valve periodically opens in order to allow the carbon dioxide to enter the second housing and the second diffusion system diffuses a portion of the attractant which attractant mixes with the carbon dioxide to form the mixture and the mixture is released from the second housing via the second opening and wherein the second light attracts some of the insects such that the insects get caught in a second air stream produced by the second fan and are trapped in the second mesh.

19. The trapping system as in claim 18 wherein the attractant is octenol.

20. The trapping system as in claim 18 wherein the first housing and the second housing are attached to a first post and the third housing and the fourth housing are attached to a second post.

21. The trapping system as in claim 18 wherein the first controller controls the first light and the first fan and the second controller controls the second light and the second fan.

22. The trapping system as in claim 18 wherein the first dispersion system comprises a first plug having a first wick that has absorbed the attractant, the first plug being removably received within the first housing and the second dispersion system comprises a second plug having a second wick that has absorbed the attractant, the second plug being removably received within the second housing.

23. The trapping system as in claim 18 wherein the first dispersion system comprises a first receptacle holding the attractant, the first receptacle being removably received within the first housing a first wick that absorbs the attractant, and a first piezoelectric crystal that ignites and vaporizes a portion of the attractant on the first wick, the first piezoelectric crystal being controlled by the first controller and the second dispersion system comprises a second receptacle holding the attractant, the second receptacle being removably received within the second housing a second wick that absorbs the attractant, and a second piezoelectric crystal that ignites and vaporizes a portion of the attractant on the second wick, the second piezoelectric crystal being controlled by the second controller.
